(19) United States
(12) Patent Application Publication
(10) Pub. No.: US 2020/0032380 A1
(43) Pub. Date: Jan. 30, 2020

(54) METHOD OF HEAT-TREATING A TITANIUM ALLOY PART

(71) Applicant: EOS GmbH Electro Optical Systems, Krailling (DE)

(72) Inventors: Atte Antikainen, Tampere (FI); Katri Kakko, Turku (FI)

(73) Assignee: EOS GmbH Electro Optical Systems, Krailling (DE)

(21) Appl. No.: 16/482,424

(22) PCT Filed: Jan. 17, 2018
(86) PCT No.: PCT/EP2018/051136

§ 371 Date: Jul. 31, 2019

(30) Foreign Application Priority Data
Feb. 7, 2017 (EP) 17155036.1

(51) Int. Cl. C22F 1/18; C22C 14/00

(52) U.S. Cl. CPC C22F 1/183; B33Y 70/00; C22C 14/00

(57) ABSTRACT

Disclosed is a method of heat-treating a titanium alloy part resulting from an additive manufacturing procedure, including arranging the titanium alloy part in an oven; heating to a first annealing temperature; maintaining the first annealing temperature for a first annealing duration; heating to a second annealing temperature, wherein the second annealing temperature exceeds the first annealing temperature; and subsequently cooling the titanium alloy part to room temperature. Further disclosed is a titanium alloy part that has been heat-treated using such a method.

### FIELD OF THE INVENTION

The invention describes a method of heat-treating a titanium alloy part resulting from an additive manufacturing procedure.

### BACKGROUND OF THE INVENTION

Certain titanium alloys such as Titanium 6-aluminum 4-vanadium (also referred to as “Ti-6A1-4V” or simply “Ti64”) are characterized by favourably high specific strength and corrosion resistance. Titanium alloys are lightweight and have high tensile strength, and are used in a wide variety of applications. Ti64 is biocompatible and is therefore widely used in biomedical applications, for example as dental implants, orthopaedic joint replacements, bone plates, etc. Conventional automated machine tooling techniques can manufacture Ti64 parts from wrought or cast bar stock, carrying out thermomechanical processing steps and plastic deformation to achieve the desired material characteristics such as ductility, tensile properties, etc. The mechanical properties of a titanium alloy part are largely determined by the microstructure that develops during the processing steps. Since it is very important to ensure fatigue resistance, especially high cycle fatigue (HCF) resistance, conventional manufacturing techniques can include various steps of plastic deformation to achieve a desired ductility for a titanium alloy part. In such a thermomechanical processing step, semi-products such as bars, tubes, billets, sheets and plates are hot-formed by rolling or forging under specific conditions so that plastic strain and dislocations are induced into the matrix, giving rise to recrystallization in deformed grains. The aim is to achieve a fine grained microstructure, for example an equiaxed microstructure.

Additive manufacturing (AM) is an alternative to automated machine tooling in manufacturing a titanium alloy part. One AM approach uses a layer-by-layer technique, also referred to as powder bed fusion, in which a metal powder or powder mixture is used as raw material or building material to build solid objects by controlled fusing, e.g. by a laser beam. Fused layers are gradually built up in the shape of the desired part, which can be very intricate. An example of such an additive manufacturing technique is selective laser melting (abbreviated to SLM in the following), sometimes also referred to as direct metal laser sintering (abbreviated to DMLS in the following). In the following, the terms “SLM part”, “SLM Ti64 part” (as a particular SLM part), “DMLS part”, “DMLS Ti64 part” (as a particular DMLS part) etc. may be regarded as synonyms when referring to a part that has been built in this manner. The microstructure of an SLM part has some advantages over a conventionally produced part. For example, an SLM part may exhibit a favourably fine initial microstructure and/or high tensile properties.

However, during SLM, the heating and cooling cycles are very rapid and affect only a thin layer at a time. This leads to residual stresses that can exceed the ultimate tensile strength of the material, and may result in poor dimensional accuracy or cracking, and which may also have a detrimental effect on fatigue crack growth. The ductility of an SLM Ti64 part may therefore be unfavourably low. This cannot be remedied by plastic deformation, since the “as manufactured” SLM part already has its final shape. For various reasons, it is generally not possible to apply the conventional metallurgical techniques of heat treatment to an SLM part with the aim of increasing its ductility, since SLM-processed Ti64 responds differently to conventionally processed Ti64 to heat-treatments. The reason for this may lie in the initial microstructure of the SLM Ti64 material. Therefore, when conventional heat treatment steps are applied to a titanium alloy part made by SLM, the treatment does not necessarily result in a morphology and/or microstructure associated with a desired degree of ductility.

Therefore, it is an object of the invention to provide an improved way of treating a titanium alloy part, which can preferably overcome the problems mentioned above.

### SUMMARY OF THE INVENTION

The object of the invention is achieved by the method of claim 1 of heat-treating a titanium alloy part resulting from an additive manufacturing procedure, and by the titanium alloy part of claim 13.

According to the invention, the method of heat-treating the titanium alloy part comprises the steps of arranging the titanium alloy part in an oven; heating (i.e. the oven with the titanium alloy part) to a first annealing temperature; and maintaining the first annealing temperature for a first annealing duration. This first annealing step is followed by a step of heating to a second annealing temperature, wherein the second annealing temperature exceeds the first annealing temperature; and subsequently cooling the titanium alloy part to room temperature.

In an “alpha+beta” (α+β) type titanium alloy, it is known that a proportion of the titanium atoms aligns in the α phase, and a proportion aligns in the β phase. In Ti64, aluminium acts as an α-stabilizing element to provide strength without affecting ductility disadvantageously, and vanadium is used as a β-stabilizing element. When the titanium alloy powder is fused by laser during SLM, the heating and cooling rates in the material are very high, resulting in metastable microstructures that are characteristic of parts made by additive manufacturing. During SLM, for instance, acicular a′ (“alpha prime”) martensite forms from the β phase and is the as-manufactured microstructure for an SLM Ti64 part.

The inventive method, when performed on a titanium alloy part that has been manufactured in an additive manufacturing procedure, can alter the microstructure of the part to achieve a desired degree of ductility. The combination of a first annealing step, followed by a second annealing step at a higher temperature, has been shown to significantly alter the microstructure of a titanium alloy part in an advantageous manner.

The microstructure of a titanium alloy part, after heat-treating using the inventive method, exhibits a duplex lamellar microstructure that is associated with increased ductility. The first annealing step initiates martensite decomposition, while the second annealing step is performed to complete martensite decomposition and to achieve an essentially fully lamellar microstructure in the titanium alloy part. With the inventive method, the ductility of the titanium alloy part can potentially be increased, while its microstructure and morphology advantageously retain their lamellar nature.

According to the invention, the titanium alloy part is heat-treated using the inventive annealing method, and subsequently exhibits a favourably higher degree of ductility. This can be very desirable, particularly for applications that require high fatigue resistance, particularly HCF resistance.

Observations carried out in the course of the invention have shown that the reason for the different response of SLM titanium alloy parts to the conventional processing techniques lies in the initial microstructure of the SLM titanium alloy part. The initial phase structure affects the reaction kinetics, and the initial lamellar morphology prevents grain globularization during the conventional heat-treating methods, in which β stabilizers are rejected from the hexagonal close-packed α′ matrix, forming body centred cubic β precipitates on α′ grain boundaries. Without plastic deformation there is not enough driving force to break the Burger's relation between α and β. This explains why conventional heat-treatment steps cannot achieve the desired morphology in an SLM Ti64 part.

The inventive method proposes a heat-treating process that encourages β phase growth along grain boundaries, converting a′ martensite into a lamellar α+β microstructure. The result is an increased level of ductility of the SLM Ti64 part. The annealing temperatures and the durations of each annealing step determine the final lamellae size in the titanium alloy part.

The dependent claims and the following description disclose particularly advantageous embodiments and features of the invention. Features of the embodiments may be combined as appropriate. Features described in the context of one claim category can apply equally to another claim category.

In the following, it may be assumed that the titanium alloy part is the result of a SLM or DMLS procedure. Without restricting the invention in any way, it may also be assumed that the material of the titanium alloy part is Ti64 (any suitable grade). It may be assumed that the part is placed in a suitable oven using any precautions necessary to avoid unwanted diffusion into the part. An initial starting temperature may be assumed to lie within the usual room temperature range (about 20° C. to 22° C.).

It has been shown that a suitable choice of temperature and dwell time, i.e. the duration of an annealing step, can precipitate β phase in the α′ matrix. Therefore, in a particularly preferred embodiment of the invention, the first annealing temperature may comprise 650° C.±50° C. The first annealing step may be referred to in the following as a stress-relieving step. Preferably, the duration of the stress-relieving annealing step comprises at least 60 minutes, more preferably up to 120 minutes. The dwell time and temperature determine the final lamellae size. To reach the first annealing temperature, the oven can be heated at a suitable rate, for example ten or more degrees Celsius per minute.

The second annealing temperature preferably exceeds the first annealing temperature by at least 100° C., more preferably by at least 150° C. To avoid a crystal structure that is entirely β, the second annealing temperature of the inventive method is preferably a sub β transus temperature, i.e. a temperature that is below the α→β transition temperature of the titanium alloy. Above this β transus temperature, the crystal structure would be entirely β. This β transus temperature has been established to be around 1000° C. for Ti64. In a particularly preferred embodiment of the invention, therefore, the second annealing temperature is below the β transus temperature and lies in the range 850° C.±50° C. Heating to the second annealing temperature is also performed at a suitable rate.

As mentioned above, dwell time and annealing temperature determine the final lamellae size of the heat-treated part. A bi-lamellar microstructure was successfully created in SLM Ti64 using the inventive method, with a second annealing at 880° C. for at least one hour and up to two hours. A lower vanadium concentration in bi-lamellar β phase after one hour annealing may be associated with metastable alloying element concentrations. Therefore, to optimize the mechanical performance of the titanium alloy part, a two-hour second annealing step may be preferred. During the course of experimentation to verify the results of the inventive method, it was observed that a two-hour annealing at a second annealing temperature of 800° C. or 880° C. resulted in similar vanadium concentrations in the β phase, which indicates that at either of these temperatures, the α′ martensite will essentially entirely decompose into stable α+β. While the α′ martensite was essentially entirely decomposed after the second annealing step in both cases, the lamellae width (1.38 μm±0.55 μm) was smaller after a second annealing at 800° C., compared to the lamellae width (1.71 μm±0.71 μm) after a second annealing at 880° C. In theory, a smaller grain size is associated with better strength and ductility. In practice, annealing at a higher temperature has been shown by the known annealing methods to improve ductility, but also to significantly increase grain size, with a detrimental effect on the material strength. In contrast, the inventive method with its two-stage heat-treatment results in an only slightly longer grain size.

Alternatively, the step of cooling the titanium alloy part to room temperature is performed directly after reaching the second annealing temperature. In this embodiment of the inventive method, the part undergoes a second annealing at the high temperatures in the vicinity of the second annealing temperature (while heating up to the second annealing temperature, and while cooling down from the second annealing temperature). In this case, the corresponding portions of the heating-up and cooling-down steps are considered part of the annealing step, and the duration of the second annealing is considerably shorter.

After the second annealing step has been carried out, the part is cooled to room temperature. This can be done by forced cooling or convection cooling, in which a cooling gas flow (e.g. using a suitable inert gas) passes over the part. Alternatively, in a further preferred embodiment of the invention, the part can be cooled by removing it from the oven and allowing the heat to dissipate so that the part gradually reaches room temperature (about 20° C. to 22° C.).

After the two annealing steps have been completed and the part has been cooled to room temperature, a further heat-treating step may be carried out in order to age the part with the aim of bringing the part into its equilibrium state. Therefore, in a further preferred embodiment of the invention, the method comprises heating the part to an aging temperature. Ageing is generally performed at relatively low temperatures, i.e. at temperatures that are lower than annealing temperatures. In a preferred embodiment of the invention, the aging temperature comprises at least 480° C. and/or at most 550° C.

Specific combinations of temperatures and durations in the inventive method can be chosen in accordance with the part to be heat-treated. The choice of temperature and dwell times may depend on the properties and composition of the alloy. For example, in a preferred embodiment of the inventive method, the first annealing temperature comprises 650° C. and is maintained for a first annealing duration of one hour; the second annealing temperature comprises 880° C. and is maintained for a second annealing duration of two hours before allowing the twice-annealed part to cool to room temperature; and the aging temperature comprises 500° C. and is maintained for an ageing duration of 24 hours.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a graph illustrating stages of the inventive method.

FIG. 2 shows an SLM Ti64 part inside an oven for carrying out steps of the inventive method;

FIG. 3 shows an SEM micrograph of an SLM Ti64 part in its as-manufactured state;

FIG. 4 shows an SEM micrograph of an SLM Ti64 part after heat-treatment using an embodiment of the inventive method;

FIG. 5 shows an SEM micrograph of an SLM Ti64 part after heat-treatment using a conventional method.

In the drawings, like numbers refer to like objects throughout. Objects in the diagrams are not necessarily drawn to scale.

### DETAILED DESCRIPTION OF THE EMBODIMENTS

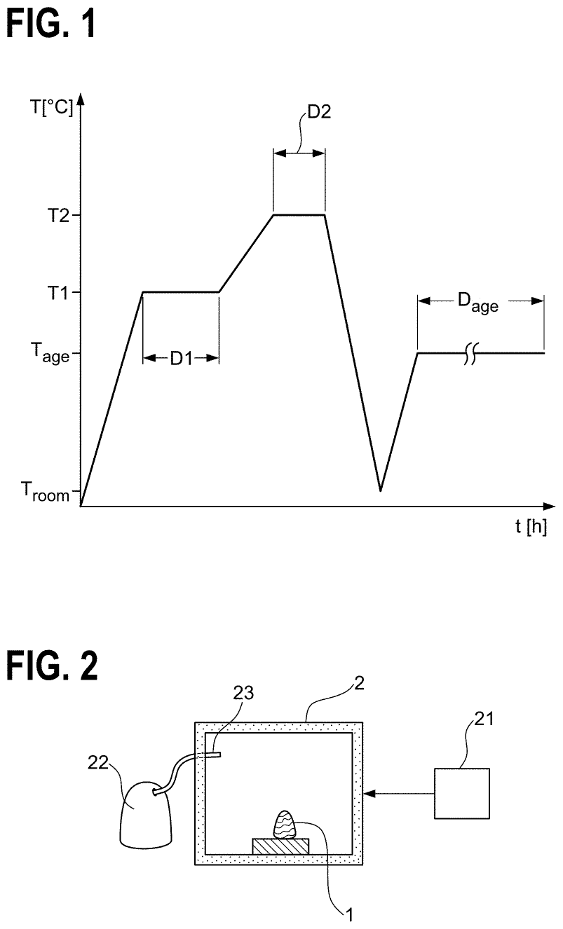

FIG. 1 shows a graph illustrating stages of the inventive method. The X-axis shows time in hours, while the Y-axis shows temperature in degrees Celsius. The SLM part to be heat-treated may be assumed to be placed in an oven or furnace. In a first step, the furnace is heated to a first annealing temperature T1. This first temperature is maintained for a first annealing duration D1, and serves to initiate a′ martensite decomposition. The furnace temperature is then raised to a second annealing temperature T2. This second annealing temperature T2 is significantly higher than the first annealing temperature T1, and is lower than the β transus temperature of the titanium alloy. The second annealing step serves to achieve an essentially lamellar microstructure and to achieve a′ martensite decomposition into stable α+β. After the second annealing step, the part is cooled to room temperature Tᵣₒₒₘ.

A number of combinations are possible for the annealing temperatures T1, T2 and the annealing durations D1, D2. For example, the first annealing temperature T1 can lie in the range 600-700° C. The first annealing duration D1 can be at least one hour, and can extend up to two hours. The second annealing temperature T2 can lie in the range 800-900° C. After heating the furnace to the second annealing temperature T2, the furnace temperature can be maintained for a while, for example for a second annealing duration D2 of up to two hours. Alternatively, after heating the furnace to the second annealing temperature T2, the temperature of the titanium alloy part can be allowed to drop to room temperature Tᵣₒₒₘ, so that the second annealing duration D2 is considerably shorter. The step of cooling the titanium alloy part can be done by forced cooling or by air-cooling as appropriate. The cooling step can be performed in a controlled manner, since the cooling rate may further influence the microstructure of the annealed part 1.

After the part has cooled to room temperature Tᵣₒₒₘ, it can be re-heated to age it. Ageing may be desired to improve the material properties of the part. To this end, the part can be arranged in the oven and heated to an aging temperature T_{age} in the range 480-550° C. The ageing temperature T_{age} can be maintained for a desired ageing duration D_{age}, for example 24 hours.

FIG. 2 shows a heat-treatment setup, with a Ti64 part 1 placed inside an oven 2. The oven 2 can be part of an additive manufacturing assembly, for example a container of a heat-treatment station of the additive manufacturing assembly. A temperature controller 21 is used to raise and lower the temperature of the oven interior in keeping with a specific heat-treatment sequence. A gas inlet 23 is provided to fill the oven interior with an inert gas such as argon from a supply 22. The oven can be of any suitable type, as will be known to the skilled person.

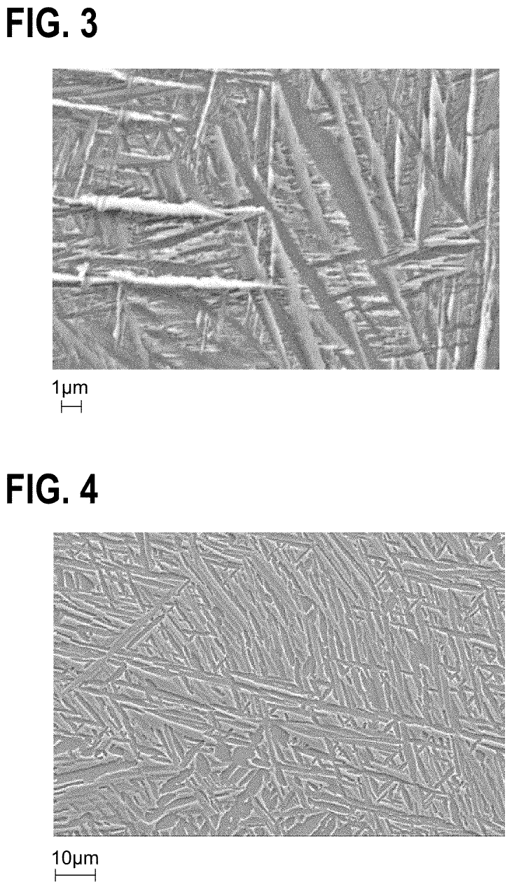

FIG. 3 shows an SEM micrograph of an SLM Ti64 part 1 in its as-manufactured state, i.e. after completion of the selective laser melting process, and before any heat-treatment has been carried out. The microstructure consists essentially of a′ martensite and has a very small grain size, as a result of the rapid cooling cycles during the SLM process. The as-manufactured state is associated with poor ductility on account of residual stresses, a metastable microstructure and a very fine grain size.

FIG. 4 shows an SEM micrograph of the SLM part 1 after heat-treatment using an embodiment of the inventive method, in this case a first annealing step at 650° C. for two hours, followed by a second annealing step at 880° C. for one hour. The resulting bi-lamellar α+β microstructure is essentially devoid of martensite, with a larger grain size. The heat-treated part exhibits an improved fatigue resistance.

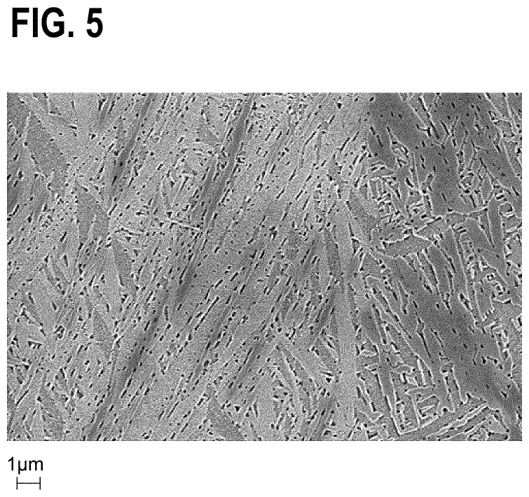

FIG. 5 shows an SEM micrograph of an SLM part after heat-treatment using a conventional method, in this case by a stress-relieving annealing step for two hours at 650° C., followed by an ageing step at a temperature well below the annealing temperature. This conventional heat-treatment method, when applied to an SLM part, results in a microstructure with incomplete a′-decomposition. This results in residual stresses in the material and metastable alloy concentrations, associated with poor ductility.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method of heat-treating a titanium alloy part resulting from an additive manufacturing procedure, which method comprises the steps of
arranging the titanium alloy part in an oven;
heating to a first annealing temperature;
maintaining the first annealing temperature for a first annealing duration;
heating to a second annealing temperature, wherein the second annealing temperature exceeds the first annealing temperature; and subsequently
cooling the titanium alloy part to room temperature.

2. A method according to claim 1, wherein the first annealing temperature lies in the range 650° C.±50° C.

3. A method according to claim 1, wherein the first annealing duration comprises at least 60 minutes.

4. A method according to claim 1, wherein the second annealing temperature is a sub beta transus temperature of the titanium alloy.

5. A method according to claim 1, wherein the second annealing temperature lies in the range 850° C.±50° C.

6. A method according to claim 1, wherein the second annealing temperature exceeds the first annealing temperature by at least 100° C.

7. A method according to of claim 1, wherein the step of cooling the titanium alloy part to room temperature is performed directly after reaching the second annealing temperature.

8. A method according to claim 1, comprising a step of maintaining the second annealing temperature for a second annealing duration, wherein the second annealing duration comprises at most 120 minutes.

9. A method according to claim 1, comprising the step of arranging the cooled titanium alloy part in an oven and heating to an aging temperature, wherein the aging temperature is lower than the first annealing temperature.

10. A method according to claim 1, wherein the aging temperature comprises 515° C.±35° C.

11. A method according to claim 1, wherein the step of cooling the titanium alloy part is performed by air-cooling.

12. A method according to claim 1, wherein the first annealing temperature comprises 650° C. and is maintained for a first annealing duration of one hour; and wherein the second annealing temperature comprises 880° C. and is maintained for a second annealing duration of two hours; and wherein an optional ageing step is performed at an aging temperature of 500° C. for an ageing duration of 24 hours.

13. A titanium alloy part which has been heat-treated using the method according to claim 1.

14. A titanium alloy part according to claim 13, wherein the titanium alloy part is the product of a selective laser melting or sintering procedure.

15. A titanium alloy part according to claim 13, wherein the titanium alloy part is made of Ti-A16-V4.
